(19) United States
(12) Patent Application Publication
(10) Pub. No.: US 2009/0201222 A1
(43) Pub. Date: Aug. 13, 2009

(54) Multiple screens for laptops, monitors, portable devices

(76) Inventor: Sorin Damian, San Jose, CA (US)

Correspondence Address: Sorin Damian, 3344 Yuba Ave., San Jose, CA, 95117, US

(21) Appl. No.: 11/339,009

(22) Filed: Feb. 11, 2008

(51) Int. Cl. G09G 5/00

(52) U.S. Cl. 345/1.1

(57) ABSTRACT

xFlexVision offers concept offers a simple, inexpensive solution to users on the road, at their desk, or at their leisure time the capability to see, work, enjoy simultaneously with larger monitors/screens or multiple screen then usually their devices provide. The concept of xFlexVision presents an affordable, integrated multiple monitor system for desktop computers, laptops, television sets, other standalone or mobile telecommunication or personal electronic devices (PDA, GPS, cellular phones, cameras, camcorders, MP3/MPEG, etc).

xFlexVision offers users on the road, at their desk, or at their leisure time the capability to see, work, enjoy simultaneously with larger monitors/screens or multiple screen then usually their devices provide. The concept of xFlexVision presents an affordable, integrated multiple monitor system for desktop computers, laptops, television sets, other standalone or mobile telecommunication or personal electronic devices (PDA, GPS, cellular phones, cameras, camcorders, MP3/MPEG, etc).

### SPECIFICATION

Currently, computers, laptops, television sets, other standalone or mobile telecommunication or personal electronic devices (PDA, GPS, cellular phones, cameras, camcorders, MP3/MPEG, etc) in standard configuration feature only one screen. Computer users in any environment, home or office, usually run multiple programs, applications simultaneously, more then often using and moving data from one application to another, is not easy when using one monitor. In some cases the user can add more then one monitor to the computer, to wide the screen, for better access to the data and multiple applications. Users had to see and deal with several application window screens simultaneously. The current industry standard operating system, Windows™ XP/Vista, Apple™ X10/Leopard allow the use of multiple monitors.

The same need for extended monitor/screen real estate is experience by users of television sets, as well as stand alone or portable/mobile telecommunications solutions, and other stand alone or mobile personal electronic devices like digital cameras and camcorders, PDA, GPS, cellular phones, MP3/MPEG, etc.

To satisfy the need for screens big enough to enable simultaneous vision of multiple programs/applications/graphics, without distorting or masking un-readable, the computer industry currently offered two answers:
Higher resolutions, bigger screens—with their real estate screen limitations, and increased desk, or portability space requirements
Multiple computers for same user—with their costs and desk space implications

The answer to extended monitors/screens space for other applications (television, telecommunications, etc.) has come only in terms of bigger screens with their disadvantages where price is not the last one.

The xFlexVision concept offers a simple, inexpensive solution for using multiple, extended screens on the same device desk computers, laptops, television sets, as well as stand alone or portable/mobile telecommunications solutions, and other personal electronic devices [digital cameras and camcorders, PDA, GPS, cellular phones, MP3/MPEG, etc.

The concept of xFlexVision presents an affordable, integrated multiple monitor/screen system.

xFlexVision starts by identifying three separate ways, equally applicable to any device with a monitor/screen to provide an extra screen/monitor real estate space:

Snap-on

One extra (or several) thin screen/monitor can be snapped-on (on grips or hinges) to the existing video monitor/screen screen of any desktop laptops, television sets, other standalone or mobile telecommunication or personal electronic devices (PDA, GPS, cellular phones, MP3/MPEG, etc.). The attachment may be execute by any appropriate methodology, including grasps, hinges, etc., and may use connected using appropriate connectors, embedded or otherwise provided by either the equipment or its monitor/screen.

Pull-Out

One extra (or several) thin screen/monitor can be pulled-out completely or partially, based on user's needs, from the equipment or its monitor/screen. The equipment's hardware and software capability may allow that the extra pulled-out monitor/screen(s) use the same or different resolution as the base monitor, as well as other user defined options. When pulled-out completely the extra monitor/screen(s) may be angled the to the viewers convenience.

Roll-Out

One extra (or several) thin flexible screens/monitor can be rolled-out completely or partially, The equipment's hardware and software capability may allow that the extra rolled-out monitor/screen(s) use the same or different resolution as the base monitor, as well as other user defined options. When rolled-out partially or completely the extra monitor/screen(s) may be angled the to the viewers convenience.

In practical terms, any combination of the snap-on, pull-out, and roll-out me be used.

### ADVANTAGES OF THE INVENTION

It meets ever increasing users' need of screen space,
It offers a far less costly solution,
It is similarly applicable to desk computers, laptops, television sets, as well as telecommunications solutions, and other standalone or mobile telecommunication or personal electronic devices (digital cameras and camcorders, PDA, GPS, cellular phones, MP3/MPEG, etc)
Requires less desk or portability real estate,
It allows rapid implementation with current technologies requiring little changes (Snap-on)
It provides the necessary flexibility to anticipate further technology screens/displays developments
It allows designers and manufacturers to use specific design forms to fit the pattern of their products
The concept is flexible and allows implementation of various thin displays technologies (not only LCD type)
The concept allows also for “foldable” displays/screens
The concept allows also for bending, rotating, folding extra displays/screens

### DESCRIPTION OF THE DRAWINGS

### Snap-On Examples

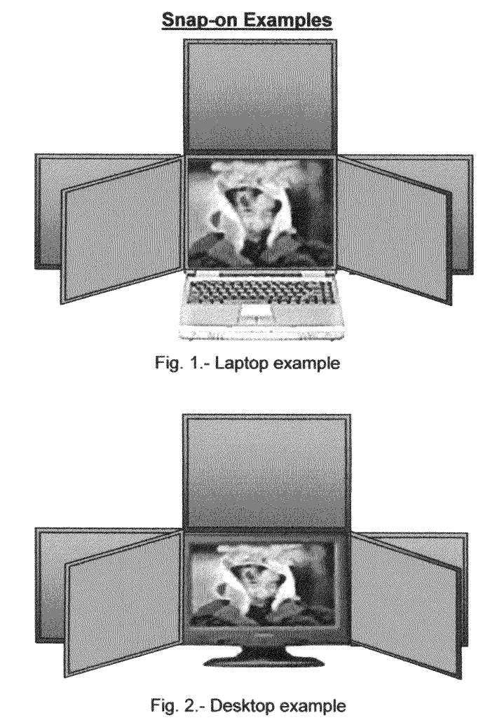

FIG. 1. —Laptop example

The picture is an example of how the snap-on style would look like when used as attachments to laptops.

FIG. 2. —Desktop example

The picture is an example of how the snap-on style would look like when used as attachments to desktops.

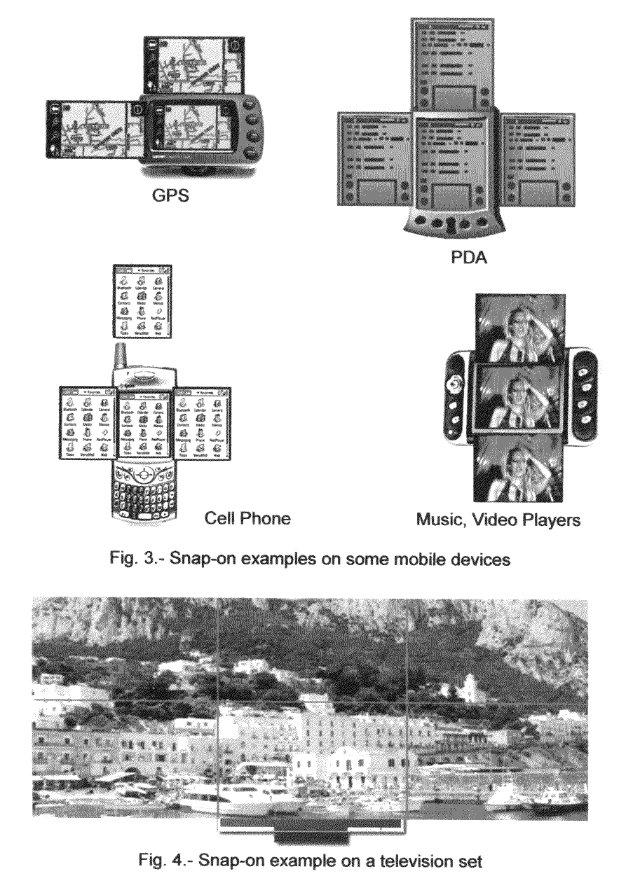

FIG. 3. —Snap-on examples on some mobile devices

These pictures are examples of how the snap-on style would look like when used as attachments to some mobile devices.

FIG. 4. —Snap-on example on a television set

The picture is an example of how the snap-on style would look like when used as attachments to television sets.

### Pullout Examples

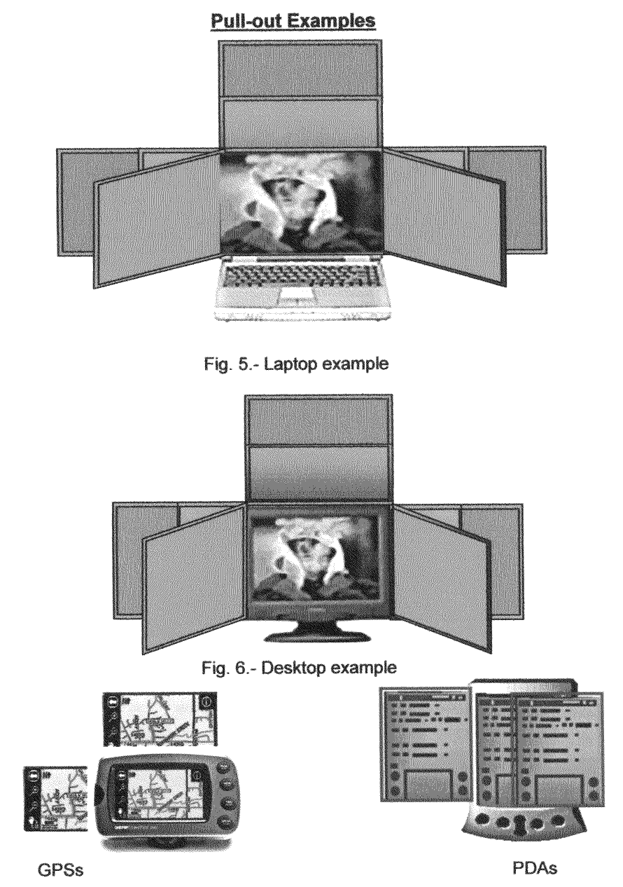

FIG. 5. —Laptop example

The picture is an example of how the pull-out style would look like when used in conjunction with laptops.

FIG. 6. —Desktop example

The picture is an example of how the pull-out style would look like when used in conjunction with desktops.

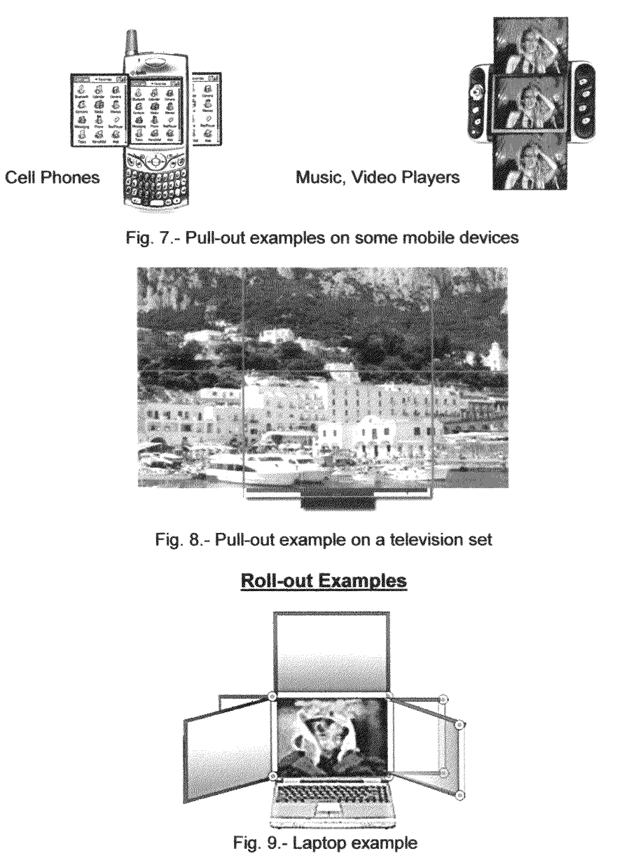

FIG. 7. —Pull-out examples on some mobile devices

These pictures are examples of how the pull-out style would look like when used as attachments to some mobile devices.

FIG. 8. —Pull-out example on a television set

The picture is an example of how the pull-out style would look like when used as attachments to television sets.

Roll-Out Examples

FIG. 9. —Laptop example

The picture is an example of how the roll-out style would look like when used in conjunction with laptops.

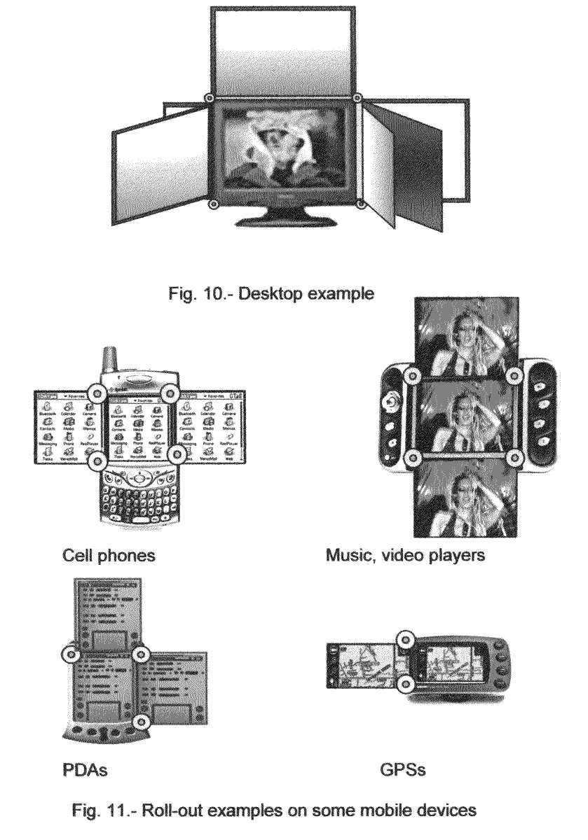

FIG. 10. —Desktop example

These pictures are examples of how the roll-out style would look like when used as attachments to some mobile devices.

FIG. 11. —Roll-out examples on some mobile devices

These pictures are examples of how the roll-out style would look like when used as attachments to some mobile devices.

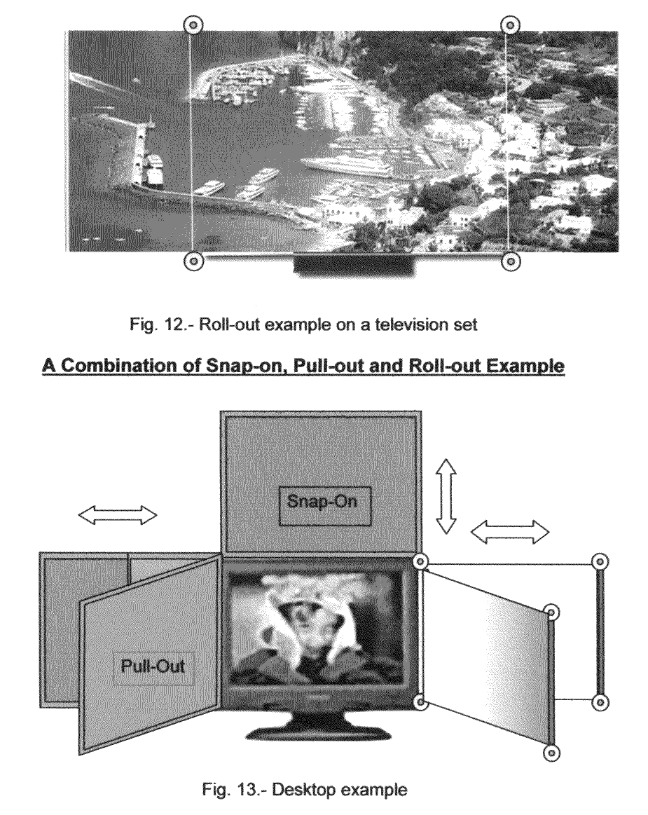

FIG. 12. —Roll-out example on a television set

The picture is an example of how the roll-out style would look like when used as attachments to television sets.

### A Combination of Snap-on, Pull-Out and Roll-Out Example

FIG. 13. —Desktop example

The picture is an example of a combination of snap-on, pull-out, roll-out extra screen on the same device.

xFlexVision offers users on the road, at their desk, or at their leisure time the capability to see, work, enjoy simultaneously with larger monitors/screens or multiple screen then usually their devices provide. The concept of xFlexVision presents an affordable, integrated multiple monitor system with applications for but not limited to desktop computers, laptops, television sets, other standalone or mobile telecommunication or personal electronic devices (PDA, GPS, cellular phones, cameras, camcorders, MP3/MPEG, etc).

1. The fastest approach to achieve more screen real estate on the same device is the one that requires least modifications to current products on the market. This approach offers the most economical method and is attain by connecting edge to edge two or several flat screens. The generic term “snap-on” was used to describe this style. The specification and arrangements of electrical and mechanical connections, either fixed or flexible, may differ from equipment to equipment, design to design and application to application. Moreover, for similar application the actual methods and appearance may differ in format, color, aspect, fixture, etc. thus offering the flexibility required by the market. This approach does not require the development of any new technology. The design of the implementation is the one that differentiates vendors for their equipment applications. The angle of the attachment, the electronic settings (resolution, brightness, contrast, etc.) may be done either automatically to match the base screen, or may by adjusted by the user.
The settings on attached screens may automatically adapt to and extend from the base screen, or it may be set up by the user based on the practical needs of the application.

2. A more elaborate approach, that still does not require extensive product development is presented by what we generically call “pull-out”. The “pull-out” of additional monitor/screen(s) may be executed from behind the main screen or from another part of the electronic device that allows the action and the alignment with the main screen. This is presented by connecting edge to edge or partially extended of two or several flat screens. Once pulled-out the extra monitor/screen(s) may use the same setting as the base screen, or may be set by the user as seem fit to the application. When pulled-out completely the extra screen(s) may be angled the to the viewers convenience. The specification and arrangements of electrical and mechanical connections, either fixed or flexible, may differ from application to application. For similar application the actual methods and appearance may differ in format, color, aspect, fixture, etc. thus responding also to the market evolution and requirements. The angle of the attachment(s), the electronic settings (resolution, brightness, contrast, etc.) may be done either automatically to match the base screen, or may by adjusted by the user.

3. In anticipation of future flat screen monitors development, the xFlexVision concept extends its application to flexible screens that can be “rolled-out” (another generic term) to increase the viable size of the basic screen. One or more flexible screens or combination flexible/solid flat screens may be used. As in previous cases once rolled-out, the extra monitor/screen(s) may use the same setting as the base screen, or may be set by the user as appropriate to the application. When rolled-out partially or completely rolled-out the extra monitor/screen(s) may be angled the to the viewers convenience. The specification and arrangements of electrical and mechanical connections, either fixed or flexible, may differ from application to application. For similar application the actual methods and appearance may differ in format, color, aspect, fixture, etc. thus responding also to the market evolution and requirements. The angle of the attachment(s), the electronic settings (resolution, brightness, contrast, etc.) may be done either automatically to match the base screen, or may by adjusted by the user.
